(19) United States
(12) Patent Application Publication
(10) Pub. No.: US 2022/0269770 A1
(43) Pub. Date: Aug. 25, 2022

(54) INFORMATION PROCESSING SYSTEM, SERVER APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventor: Toshio ITO, Kawasaki (JP)

(73) Assignee: KABUSHIKI KAISHA TOSHIBA, Tokyo (JP)

(21) Appl. No.: 17/460,964

(22) Filed: Aug. 30, 2021

(30) Foreign Application Priority Data
Feb. 25, 2021 (JP) 2021-028901

(51) Int. Cl. G06F 21/44

(52) U.S. Cl. CPC G06F 21/44

(57) ABSTRACT

According to an embodiment, an information processing system includes a first activation key storage unit that stores an activation key that validates a device key used, an activation key identifier that identifies the activation key, a maximum activation number indicating a number of the device keys that the activation key is capable of validating, and a current activation number indicating a current number of device keys validated with the activation key; and a processing unit that stores a first device key in a first device key storage unit in a case where a first current activation number of a first activation key identified by a first activation key identifier is less than a first maximum activation number, when the processing unit receives an activation request including the first device key and the first activation key identifier from the device.

### CROSS-REFERENCE TO RELATED APPLICATIONS

This application is based upon and claims the benefit of priority from Japanese Patent Application No. 2021-028901, filed on Feb. 25, 2021; the entire contents of which are incorporated herein by reference.

### FIELD

Embodiments described herein relate generally to an information processing system, a server apparatus, an information processing method, and a computer program product.

### BACKGROUND

Generally, in a cyber-physical system (CPS), a device situated on a site and a server on a cloud communicate/cooperate with each other to function as a system. At that time, the server must be set to authenticate the device as a communication partner and communicate only with trusted devices. Thus, when a new device is incorporated into the CPS, an initial registration operation is performed so that the server can authenticate the new device as a trusted device.

### BRIEF DESCRIPTION OF THE DRAWINGS

FIG. 1 is a view illustrating an example of a device configuration of an information processing system of a first embodiment;

FIG. 2 is a view illustrating an example of a functional configuration of a server apparatus of the first embodiment;

FIG. 3 is a view illustrating an example of a functional configuration of a device of the first embodiment;

FIG. 4 is a view illustrating an example of a functional configuration of a setting tool of the first embodiment;

FIG. 5 is a view illustrating an example of a processing sequence of an initial registration operation of the first embodiment;

FIG. 6 is a view illustrating an example of a processing sequence of a setting operation of the first embodiment;

FIG. 7 is a view illustrating an example of a processing sequence of service provision of the first embodiment;

FIG. 8 is a view illustrating an example of a processing sequence of fraud detection of the first embodiment;

FIG. 9 is a view illustrating an example of a functional configuration of a server apparatus of a second embodiment;

FIG. 10 is a view illustrating an example of a functional configuration of a device of the second embodiment;

FIG. 11 is a view illustrating an example of a functional configuration of a setting tool of the second embodiment;

FIG. 12 is a view illustrating an example of a processing sequence of a setting operation of the second embodiment; and

FIG. 13 is a view illustrating an example of a hardware configuration of the server apparatus of the first and second embodiments.

### DETAILED DESCRIPTION

According to an embodiment, an information processing system includes a server apparatus, and a device. The server apparatus includes a first activation key storage unit, and a processing unit. The first activation key storage unit stores an activation key that validates a device key used when the device receives a service of the server apparatus, an activation key identifier that identifies the activation key, a maximum activation number indicating a number of the device keys that the activation key is capable of validating, and a current activation number indicating a current number of device keys validated with the activation key. The processing unit stores a first device key in a first device key storage unit in a case where a first current activation number of a first activation key identified by a first activation key identifier is less than a first maximum activation number, when the processing unit receives an activation request including the first device key and the first activation key identifier from the device. The device includes a second device key storage unit, a second activation key storage unit, and an activation request unit. The second device key storage unit stores the first device key. The second activation key storage unit stores the first activation key and the first activation key identifier. The activation request unit transmits the activation request to the server apparatus.

Hereinafter, embodiments of an information processing system, a server apparatus, an information processing method, and a program will be described in detail with reference to the accompanying drawings.

In an initial registration operation when a new device is incorporated into a CPS, an operation of registering identification information and the like of the device in a server is performed. In this registration operation, if an encryption key used for authentication of the device is illegally leaked, an unauthorized device replaces a legitimate device and can be connected to the server. Thus, in the initial registration operation, a mechanism for minimizing a risk of key leakage and blocking unauthorized connection to the server as soon as possible even in the case of leakage is important.

Hereinafter, an embodiment in which even if an activation key is leaked, the leakage is detected, and the leaked key is quickly invalidated, thus making it difficult for an attacker to illegally use the leaked key will be described.

### First Embodiment

First, an example of a device configuration of an information processing system of a first embodiment will be described.

Example of Device Configuration

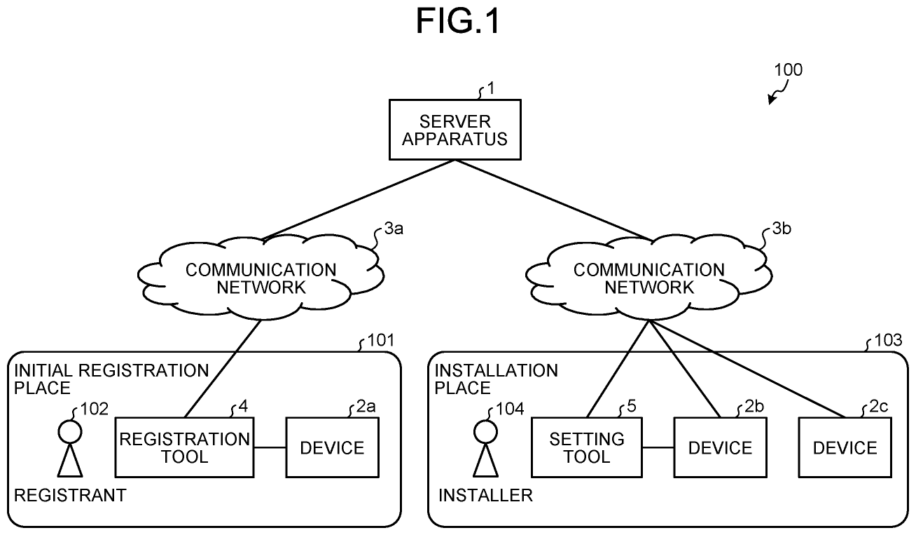

FIG. 1 is a view illustrating an example of the device configuration of an information processing system 100 of the first embodiment. The information processing system 100 of the first embodiment includes a server apparatus 1, devices 2a to 2c, communication networks 3a and 3b, a registration tool 4, and a setting tool 5.

Hereinafter, when the devices 2a to 2c are not distinguished from each other, the devices 2a to 2c are simply referred to as the device 2. Similarly, when the communication networks 3a and 3b are not distinguished from each other, the communication networks 3a and 3b are simply referred to as the communication network 3.

The server apparatus 1 communicates with the device 2, the registration tool 4, and the setting tool 5 to provide various services. The server apparatus 1 is built on a cloud service, for example, and communicates with the device 2 and the like via a communication network such as the Internet. Communication between the server apparatus 1 and the device 2 and the like is protected by a technology such as TLS (Transport Layer Security). When communicating with the server apparatus 1, the device 2 or the like authenticates the server apparatus 1 by verifying an electronic certificate of the server apparatus 1.

The device 2 is a device having a function of measuring and controlling the state of the physical world, such as a sensor and an actuator. In addition, the device 2 has a function of communicating with the server apparatus 1 via the communication network 3. The device 2 is first subjected to initial registration operation by a registrant 102 at an initial registration place 101 (in the example of FIG. 1, device 2a). Thereafter, the device 2 is installed in an installation place 103 by an installer 104 (in the example of FIG. 1, the devices 2b and 2c), and performs its function in cooperation with the server apparatus 1.

The communication network 3a is a network for the server apparatus 1 to communicate with the registration tool 4 and the device 2a. The communication network 3a includes, for example, the Internet, a LAN (local area network) of the initial registration place 101, an access network connecting them, and the like.

The communication network 3b is a network for the server apparatus 1 to communicate with the setting tool 5 and the devices 2b and 2c. Similarly, the communication network 3b includes, for example, the Internet, the LAN of the installation place 103, an access network connecting them, and the like.

The initial registration place 101 is a place where the registrant 102 performs the initial registration operation of the device 2a. For example, the initial registration place 101 is a factory that manufactures the device 2a. The registrant 102 is an operator who performs the initial registration operation of the device 2a. The registrant 102 has a user account in the server apparatus 1 and has authority to issue and browse an activation key pair. In the initial registration operation, the registration tool 4 installs an activation key (described later) in the device 2a on the basis of the operation of the registrant 102.

The registration tool 4 is, for example, a tool (for example, a notebook PC or the like) used by the registrant 102 in the initial registration operation. In the example of FIG. 1, the registration tool 4 communicates with the server apparatus 1 and the device 2a, and performs the initial registration operation according to the operation of the registrant 102.

The installation place 103 is a place where the device 2 is finally installed. The installation place 103 is, for example, a house or a facility owned by a customer of the registrant 102. In the example of FIG. 1, the devices 2b and 2c measure and control a state of the installation place 103 (physical world) in cooperation with the server apparatus 1.

The installer 104 is an operator who installs the device 2 at the installation place 103. The installer 104 is, for example, a person entrusted by the registrant 102. The installer 104 has a user account in the server apparatus 1, and has authority to issue an activation token to be described later and has authority of revocation (invalidation of leaked key) at the time of fraud detection, and the like. In the example of FIG. 1, the installer 104 installs the devices 2b and 2c at places designated by the registrant 102, the customer of the registrant 102, and the like, and performs setting operation on the devices 2b and 2c using the setting tool 5. When the setting operation is completed, the devices 2b and 2c can receive a service from the server apparatus 1.

The setting tool 5 is, for example, a tool (such as notebook PC) used by the installer 104 for the setting operation. The setting tool 5 communicates with the server apparatus 1 and the devices 2b and 2c, and performs the setting operation according to operation of the installer 104.

Example of Functional Configuration of Server Apparatus

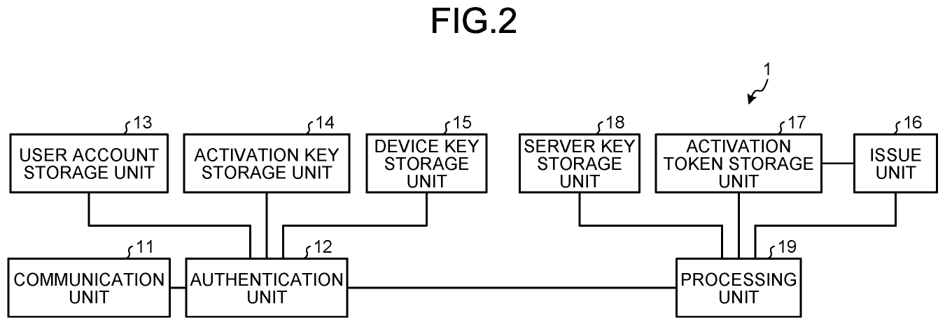

FIG. 2 is a view illustrating an example of a functional configuration of the server apparatus 1 of the first embodiment. The server apparatus 1 of the first embodiment includes a communication unit 11, an authentication unit 12, a user account storage unit 13, an activation key storage unit 14, a device key storage unit 15, an issue unit 16, an activation token storage unit 17, a server key storage unit 18, and a processing unit 19.

The communication unit 11 transmits and receives a message to and from a communication destination. For example, the communication unit 11 transmits a message to the device 2, the registration tool 4, and the setting tool 5 through the communication network 3. Furthermore, for example, the communication unit 11 receives a message from the device 2, the registration tool 4, and the setting tool 5 through the communication network 3.

The authentication unit 12 authenticates the message received by the communication unit 11. That is, the authentication unit 12 identifies a subject that has transmitted the message, and determines a method of processing the message, propriety of the processing, and the like according to the result. The authentication unit 12 authenticates the received message on the basis of information recorded in the user account storage unit 13, the activation key storage unit 14, and the device key storage unit 15.

The user account storage unit 13 stores information of a user who can use a function provided by the server apparatus 1. In the user account storage unit 13, for example, the following information is recorded for each user account.

User identifier

User's e-mail address

User password (password data subjected to encryption or hash function)

User type (registrant or installer)

A user having account information in the user account storage unit 13 logs in to the server apparatus 1 using information such as the user identifier, the e-mail address, and the password, and can use the function of the server apparatus 1 within the scope of the authority according to the user type.

The activation key storage unit 14 stores the activation key. The activation key is an encryption key used for validating (activating) a device key of the device 2 on the server apparatus 1 in the setting operation of the device 2. The activation key (pair of private key and public key) is installed in the device 2 by the registration tool 4 in the initial registration operation.

In the activation key storage unit 14, for example, the following information is recorded for each activation key.

Activation key identifier

Private key data of activation key

Public key data of activation key

Maximum activation number: maximum number of device keys that can be validated with this activation key

Current activation number: the number of device keys validated up to the present with this activation key

Identifier list of device keys (validated by this activation key)

The device key storage unit 15 stores the device key. The device key is an encryption key different for each of the devices 2, and is used when the device 2 receives a service of the server apparatus 1 after completion of the setting operation. The device key (public key) is sent from the device 2 to the server apparatus 1 by the setting operation and is validated. For example, the following information is recorded in the device key storage unit 15.

Device key identifier

Public key data of device key

Expiration of device key

Identifier of activation key used when this device key is validated

The issue unit 16 newly issues the activation token in the setting operation. The activation token demonstrates that the installer 104 has authorized activation of a certain device key.

The activation token storage unit 17 stores the issued activation token. The activation token storage unit 17 records, for example, the following information for each activation token.

Activation token character string

Corresponding activation key identifier

Expiration of activation token

The server key storage unit 18 stores a server key used to apply an authentication code to a message issued by the server apparatus 1. For example, when the authentication code is an electronic signature, the server key is a pair of a public key and a private key.

The processing unit 19 receives a message authenticated by the authentication unit 12 from a transmission source, and processes a request indicated by the received message. The processing unit 19 creates a reply message to the received message as necessary, and replies to the transmission source of the message.

Example of Functional Configuration of Device

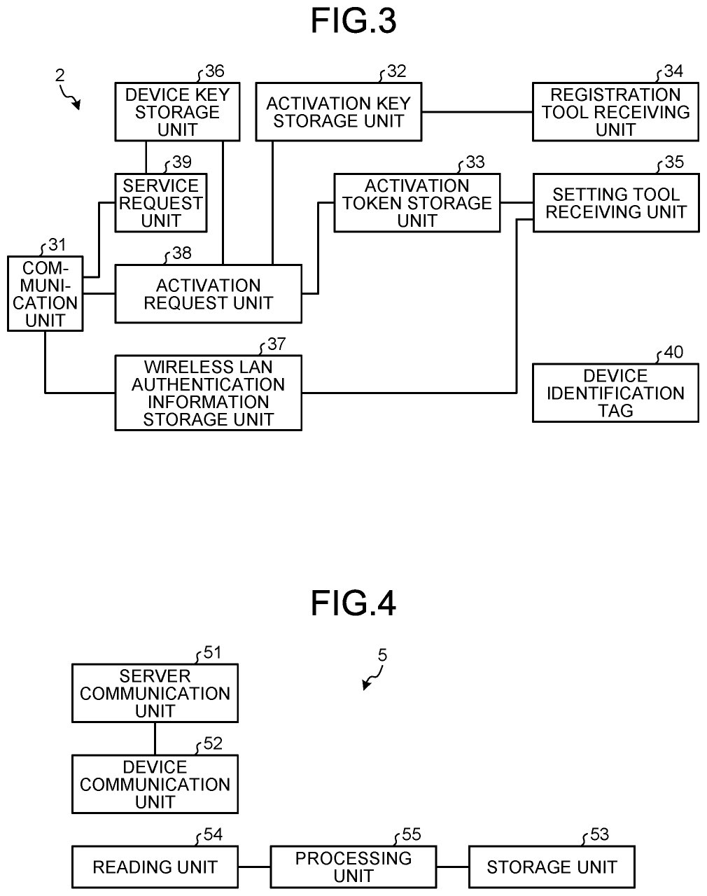

FIG. 3 is a view illustrating an example of a functional configuration of the device 2 of the first embodiment. The device 2 of the first embodiment includes a communication unit 31, an activation key storage unit 32, an activation token storage unit 33, a registration tool receiving unit 34, a setting tool receiving unit 35, a device key storage unit 36, a wireless LAN authentication information storage unit 37, an activation request unit 38, a service request unit 39, and a device identification tag 40.

The communication unit 31 transmits and receives a message to and from the server apparatus 1 via the communication network 3.

The activation key storage unit 32 stores the activation key pair (public key and private key) used to validate the device key of the device 2 and the activation key identifier for identifying the activation key.

The activation token storage unit 33 stores the activation token used to validate the device key of the device 2.

The registration tool receiving unit 34 receives an activation key pair from the registration tool 4 in the initial registration operation, and stores the activation key pair in the activation key storage unit 32.

The setting tool receiving unit 35 receives an activation token from the setting tool 5 in the setting operation, and stores the activation token in the activation token storage unit 33.

The device key storage unit 36 stores a device key pair (public key and private key) of the device 2.

The wireless LAN authentication information storage unit 37 stores access authentication information (for example, SSID (Service Set Identifier) and password) of the wireless LAN expanded in the installation place 103.

The activation request unit 38 sends an activation request to the server apparatus 1 at the time of the setting operation to validate the device key of the device 2. The authentication code using the activation key is assigned to the activation request. The authentication code is, for example, the electronic signature using the activation key (private key). When the activation key is a common key, the authentication code is, for example, a message authentication code (MAC) using the shared key.

The electronic signature using the device key (private key) is added to the activation request. The activation request unit 38 verifies that the device 2 owns the device key (private key) by including the electronic signature in the activation request.

After the setting operation is performed, the service request unit 39 sends a service request to the server apparatus 1. A signature using the device key is added to the service request.

A device identification tag is a tag indicating a device specific identifier. The device identification tag is, for example, a label on which identifier information is printed, a label on which the identifier information is printed on a QR code (registered trademark), an RFID tag in which the identifier information is recorded, or the like.

Functional Configuration of Setting Tool

FIG. 4 is a view illustrating an example of a functional configuration of the setting tool 5 of the first embodiment. The setting tool 5 of the first embodiment includes a server communication unit 51, a device communication unit 52, a storage unit 53, a reading unit 54, and a processing unit 55.

The server communication unit 51 communicates with the server apparatus 1 through the communication network 3. A message transmitted by the server communication unit 51 may include authentication information (for example, user identifier and password) of the user (for example, the installer 104) of the setting tool.

The device communication unit 52 communicates with the device 2 when the setting operation is performed.

The storage unit 53 records information on the device 2 to be installed. The storage unit 53 stores an installed device list. The installed device list includes, for example, the following information for each of the devices 2 to be installed.

Device specific identifier of device 2 to be installed

Identifier of activation key installed in device 2 to be installed

The reading unit 54 reads the device identification tag of the device 2 to be installed. The reading unit 54 is, for example, a camera that reads a QR code, an RFID (radio frequency identifier) reader, or the like.

The processing unit 55 collates the device identification tag with the installed device list.

When the new device 2 is added to the information processing system 100 of the first embodiment, the registration tool 4 first performs the initial registration operation based on the operation of the registrant 102. Before the initial registration operation is performed, the device 2 does not have the activation key, and the server apparatus 1 does not have the device key of the device 2. The device 2 may have its own device key before the initial registration operation is performed, or may generate the device key for the first time at the time of the setting operation to be described later.

Processing Example of Initial Registration Operation

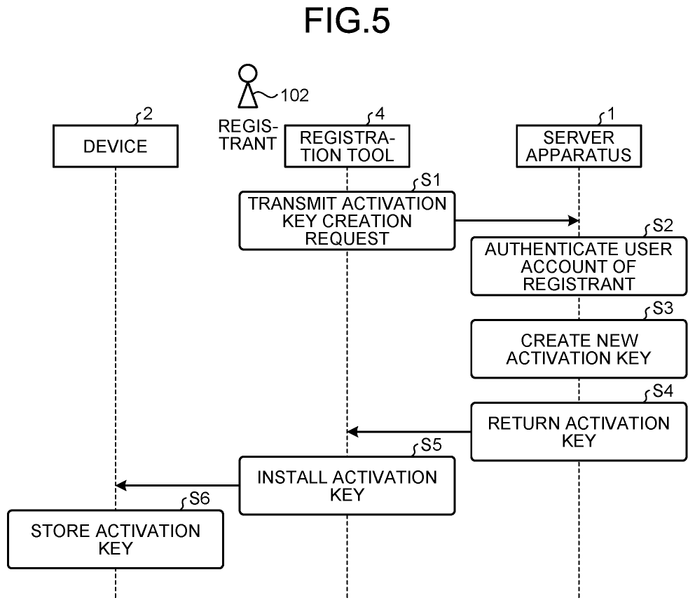

FIG. 5 is a view illustrating an example of a processing sequence of the initial registration operation of the first embodiment. In the processing sequence of FIG. 5, the server apparatus 1 issues a new activation key, and the registration tool 4 installs the activation key in the device 2 on the basis of the operation of the registrant 102.

First, the registration tool 4 sends an activation key creation request to the server apparatus 1 in response to the operation of the registrant 102 (step S1). The registration tool 4 and the server apparatus 1 communicate through the communication network 3a.

Next, when the communication unit 11 of the server apparatus 1 receives the activation key creation request, the authentication unit 12 authenticates whether the activation key creation request is made by the registrant 102 (step S2). For this authentication, for example, password authentication using the user identifier and the password stored in the user account storage unit 13 may be used. For example, authentication using a token acquired in advance by OAuth 2.0 Authorization Code Flow (RFC 6749) may be used for this authentication.

Next, when authenticity of the request is confirmed by the authentication unit 12, the processing unit 19 randomly generates a new activation key (pair of private key and public key) and stores the new activation key in the activation key storage unit 14 (step S3). At that time, the processing unit 19 sets both the maximum activation number and the current activation number to 0, and initializes the identifier list of the device key as an empty list.

Next, the communication unit 11 returns the activation key generated by the processing of step S3 to the registration tool 4 (step S4).

Next, the registration tool 4 transfers the activation key, received from the server apparatus 1, to the device 2 to install the activation key in the device 2 (step S5). The registration tool 4 and the device 2 communicate with each other through a communication method effective during the initial registration operation. The communication method effective during the initial registration operation is, for example, LAN existing in the initial registration place 101, wireless communication by Bluetooth, communication by RS232, JTAG, or the like, infrared communication, ultrasonic communication, or the like. These communication methods may be enabled only during the initial registration operation.

Next, the activation key storage unit 32 of the device 2 stores the activation key received from the registration tool (step S6).

In the above processing sequence, although the server apparatus 1 creates the new activation key, the registration tool 4 may download an existing activation key from the server apparatus 1 and install the same in the device 2. In this case, the registration tool 4 transmits an activation key acquisition request to the server apparatus 1 in response to the operation of the registrant 102, for example. After authenticating the activation key acquisition request, the server apparatus 1 reads the activation key, specified in the activation key acquisition request, from the activation key storage unit 14 and returns the read activation key to the registration tool 4.

In the above processing sequence, when a new activation key is generated, the maximum activation number is initialized to 0; however, the maximum activation number may be initialized as a number larger than 0. The device 2 in which the activation key is installed by the initial registration operation is transported to the installation place 103, installed at a predetermined position by the installer 104, and then subjected to the setting operation. At that time, the storage unit 53 of the setting tool 5 used by the installer 104 stores in advance the device specific identifier of the device 2 to be installed and a list of the activation key identifiers of the device 2. The operation of storing these pieces of information in the storage unit 53 is performed by the installer 104 himself or a person (for example, registrant 102) who requests the installer 104 to perform installation operation.

Processing Example of Setting Operation

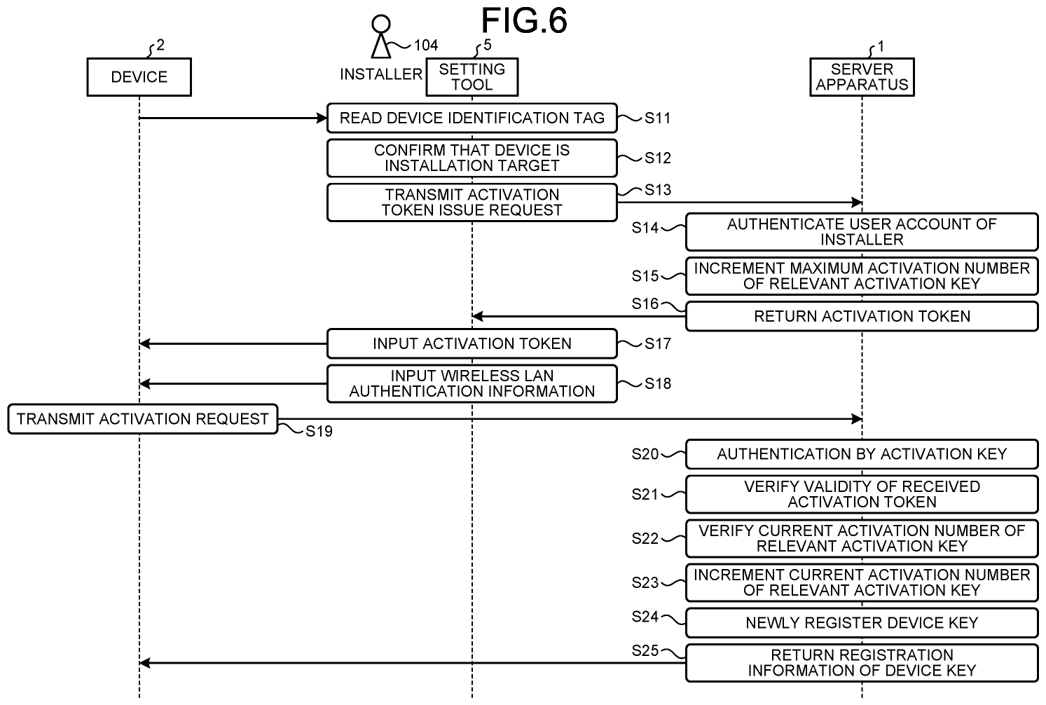

FIG. 6 is a view illustrating an example of a processing sequence of the setting operation of the first embodiment. First, the reading unit 54 of the setting tool 5 reads the device identification tag of the device 2 to be installed in response to the operation of the installer 104 (step S11).

Next, the processing unit 55 confirms that the device 2 specified from the device identification tag read by the processing of step S11 is an installation target (step S12). Specifically, the processing unit 55 collates the device specific identifier read from the device identification tag with the device specific identifier included in the installed device list in the storage unit 53. When there is no entry corresponding to the installed device list, the installer 104 is notified of the fact, and the installer 104 cancels the installation operation. When there is the corresponding entry, the processing unit 55 reads the activation key identifier of the device 2 to be installed from the storage unit 53.

Next, the server communication unit 51 transmits an activation token issue request to the server apparatus 1 (step S13). The activation token issue request includes the activation key identifier of the device 2 to be installed and the authentication information of the installer 104.

Next, upon receiving the activation token issue request from the setting tool 5, the communication unit 11 of the server apparatus 1 authenticates whether the request is issued by the installer 104 (step S14). For this authentication, password authentication using the authentication information (for example, user identifier and password) included in the activation token issue request and the authentication information (for example, user identifier and password) recorded in the user account storage unit 13 may be used, or authentication using a token acquired in advance by OAuth 2.0 Authorization Code Flow may be used. When the authentication fails, the authentication unit 12 discards the activation token issue request, and the communication unit 11 returns an error to the setting tool 5.

Next, when the authenticity of the activation token issue request is confirmed by the authentication unit 12, the processing unit 19 adds 1 to the maximum activation number of the entry of the activation key storage unit 14 corresponding to the activation key identifier included in the activation token issue request (step S15). In the present embodiment, at this time point, the maximum activation number of the entry is 1, and the current number of activations is 0.

Next, the issue unit 16 creates the activation token and returns the activation token to the setting tool 5 (step S16). Specifically, the processing unit 19 creates a new entry in the activation token storage unit 17, and sets a randomly generated character string in an activation token character string field. The processing unit 19 sets the activation key identifier, included in the activation token issue request received from the setting tool 5, in a “corresponding activation key identifier” field of the entry. The processing unit 19 sets a future time by a suitable time (for example, 10 minutes) from the current time in an expiration field. When the creation of the entry is completed, the processing unit 19 returns the activation token (character string randomly generated in activation token character string field) to the setting tool 5.

Next, when the server communication unit 51 of the setting tool 5 receives the activation token from the server apparatus 1, the device communication unit 52 inputs the activation token to the device 2 (step S17). Here, the setting tool 5 and the device 2 perform communication in the same manner as in the initial registration operation. The device 2 stores the activation token in its own activation token storage unit 17.

Next, the device communication unit 52 inputs the wireless LAN access authentication information (for example, SSID and password), expanded in the installation place 103, to the device 2 (step S18). The wireless LAN access authentication information may be stored in advance in the setting tool 5, or the installer 104 may input the wireless LAN access authentication information to the setting tool 5. The device 2 stores the wireless LAN access authentication information, received from the setting tool 5, in the wireless LAN authentication information storage unit 37. As a result, the device 2 can communicate with the server apparatus 1 through the wireless LAN of the installation place 103.

Next, the communication unit 31 of the device 2 sends the activation request to the server apparatus 1 and requests validation of the device key of the device 2 (step S19). The device 2 includes the following information in the activation request.

Device key (public key)

Activation key identifier

Activation token character string

Time at which this activation request has been created

Randomly generated request identification character string

Electronic signature created with device key (private key) for all the above information

Electronic signature created with activation key (private key) for all the above information

Next, when the communication unit 11 of the server apparatus 1 receives the activation request from the device 2, the communication unit 11 authenticates the authenticity of the activation request (step S20). Specifically, the authentication unit 12 first reads the activation key (public key), corresponding to the activation key identifier described in the activation request, from the activation key storage unit 14, and verifies an authentication code (in the first embodiment, electronic signature) assigned to the activation request with the public key. When the activation request is determined to be invalid as a result of the verification, the authentication unit 12 discards the activation request and stops the processing.

Next, the processing unit 19 verifies validity of the activation token included in the activation request received from the device 2 (step S21). Specifically, the processing unit 19 collates the activation token storage unit 17 using the activation token included in the activation request and extracts the corresponding entry. The processing unit 19 verifies that an expiration described in the corresponding entry is a time later than the current time. Furthermore, the processing unit 19 verifies that the activation key identifier described in the corresponding entry is the same as the activation key identifier described in the received request.

The processing unit 19 may further perform another verification processing. For example, the processing unit 19 may further verify that a creation time described in the activation request is a past time sufficiently close to the current time. Furthermore, for example, the processing unit 19 may further verify that the request identification character string of the activation request is received for the first time within a certain period of time. Further, for example, the processing unit 19 may further verify that the device key (public key) included in the activation request is not registered in the device key storage unit 15. Furthermore, for example, the processing unit 19 may further verify that the electronic signature included in the activation request can be verified with the device key (public key) included in the activation request.

When any one of the verification processing performed by the processing unit 19 fails, the processing unit 19 discards the activation request and stops the processing.

Next, when the processing unit 19 confirms the authenticity of the activation request by the above verification, the processing unit 19 reads the entry, corresponding to the activation key identifier described in the activation request, from the activation key storage unit 14, and verifies that the current activation number is less than the maximum activation number (step S22). When the current activation number is not less than the maximum activation number, the processing unit 19 creates an activation number error response, and the communication unit 11 returns the activation number error response to the device (details will be described later).

Next, when the current activation number is less than the maximum activation number, the server adds 1 to the current activation number and updates the activation key storage unit 14 (step S23). In the present embodiment, at this time point, the maximum activation number is 1, and the current activation number is 1.

Next, the processing unit 19 newly registers an entry of the device key (public key), included in the activation request, in the device key storage unit 15 (step S24). At that time, the processing unit 19 newly issues the device key identifier of a new registration entry, sets the expiration to a time (for example, after one week) ahead of the current time by a suitable time, and sets the activation key identifier included in the activation request in a field of “identifier of the activation key used when the device key is validated”.

Next, the communication unit 11 returns registration information (device key identifier and expiration) of the newly registered device key to the device 2 (step S25).

In the above processing sequence, the setting tool 5 communicates with the device 2 in the same manner as the registration tool 4 when inputting the activation token and the wireless LAN access authentication information of the installation place 103 to the device 2. As another method, the installer 104 may directly operate an input/output device included in the device 2 to transmit these pieces of information. For example, when the device 2 includes a keyboard and a display, the installer 104 may directly input the character string indicating the activation token to the device 2 with the keyboard. In this case, the setting tool 5 displays the input character string indicating the activation token on the display or the like and presents the character string to the installer 104. Similarly, the installer 104 may directly input the wireless LAN access authentication information of the installation place 103 on the keyboard of the device 2.

In the above processing sequence, the processing unit 19 creates a new entry in the activation token storage unit 17 in response to the activation token issue request transmitted from the setting tool 5, and returns the activation token corresponding to the new entry to the setting tool 5. As another method, information necessary for the setting tool 5 may be embedded in the character string itself indicating the activation token. For example, the processing unit 19 may generate data in which the electronic signature is added to the activation key identifier included in the activation token issue request and the expiration of the activation token with the server key (private key) stored in the server key storage unit 18. Then, the communication unit 11 may encode the data generated by the processing unit 19 into the character string and send the character string as the activation token to the setting tool 5. For encoding at that time, a method such as JSON Web Token (RFC 7519) may be used. Thereafter, when the server apparatus 1 receives the activation request from the device 2, the server apparatus 1 may verify the electronic signature of the activation token included in the activation request with the server key (public key), and perform the above processing sequence using the activation key identifier and the expiration included in the token.

When the setting operation of FIG. 6 is completed, the device 2 can receive provision of the service from the server apparatus 1.

Processing Example of Service Provision

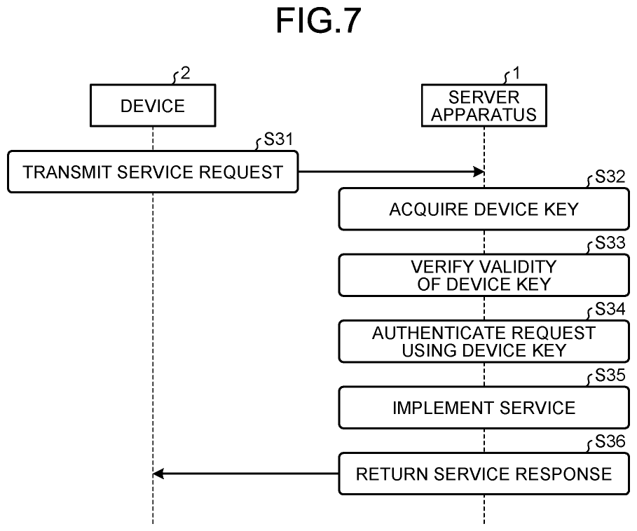

FIG. 7 is a view illustrating an example of a processing sequence of service provision of the first embodiment. First, the service request unit 39 of the device 2 creates a service request and sends the service request to the server apparatus 1 (step S31). The service request includes the following information.

Requested service specific information

Device key identifier

Time at which service request has been created

Randomly generated request identification character string

Electronic signature created with device key (private key) for all the above information

Next, when the authentication unit 12 of the server apparatus 1 receives the service request from the device 2, the authentication unit 12 acquires the device key identifier included in the service request, collates the device key storage unit 15 with the device key identifier, and reads the corresponding entry (step S32).

Next, the authentication unit 12 verifies that the expiration included in the entry read by the processing of step S32 is a time later than the current time (step S33). When the expiration is not the time later than the current time, the server apparatus 1 stops the processing, and the communication unit 11 returns an error message to the device 2.

Next, when the expiration is the time later than the current time, the authentication unit 12 verifies the electronic signature of the service request transmitted in step S31 using the device key (public key) acquired from the entry (step S34). The authentication unit 12 may further perform another verification. For example, the authentication unit 12 may further verify that a creation time included in the service request is a past time sufficiently close to the current time. Furthermore, for example, the authentication unit 12 may further verify that the request identification character string included in the service request is the request identification character string received for the first time within a certain period of time. When any one of the verifications fails, the server apparatus 1 stops the processing, and the communication unit 11 returns the error message to the device 2.

Next, the processing unit 19 reads the service specific information included in the service request transmitted in step S31, and implements a requested service (step S35).

Next, the communication unit 11 returns a result of the service implemented in step S35 as a service response to the device 2 (step S36).

As described above, the service request is authenticated using the electronic signature using the device key within the expiration.

The server apparatus 1 has a device key update service as one of the services to be provided to the device 2. When the device key is updated, the device 2 first generates a new device key pair, creates an update request including a new device key (public key) and the electronic signature using a new device key (private key), further adds the electronic signature using an old device key, and sends the update request to the server apparatus 1. The server apparatus 1 authenticates the update request using the old device key according to the above sequence. The server apparatus 1 verifies the electronic signature using the new device key (private key) with the received new device key (public key) When these verifications are passed, the server apparatus 1 updates the device key storage unit 15 to replace the old device key with the new device key (public key).

The processing sequence of the initial registration operation, the setting operation, and the service provision of the present embodiment improves security by the following features.

The device key used for authentication of the service provision is different for each of the devices 2. As a result, it is possible to suppress an influence when the device key is leaked.

The device key (private key) is always inside the device and is not exchanged with the outside. As a result, possibility of leakage of the device key is suppressed.

In order for the device 2 to validate the device key, the activation token is required, and the activation token needs to be issued to the server apparatus 1 by the installer 104 having the user account. As a result, even when an attacker who does not have an account in the server apparatus 1 has stolen the activation key, it is possible to prevent an unauthorized device key from being validated.

An upper limit of the device key that can be validated (the number of activations) is managed for each activation key, and the device key cannot be validated beyond the upper limit. As a result, even when the attacker has stolen the activation key and the activation token, it is possible to prevent the unauthorized device key from being validated.

The maximum activation number of the activation key is added for the first time when the activation token is issued. As a result, a time during which validation of a new device key can be performed is shortened. This leads to a shorter time during which the attacker can validate the unauthorized device key.

As described above, in the information processing system 100 implementing the present embodiment, although it is extremely difficult for the attacker to validate the unauthorized device key, it is still theoretically possible. However, in the present embodiment, even in such a case, unauthorized validation of the device key can be detected, and a quick response can be made.

Example of Fraud Detection Processing

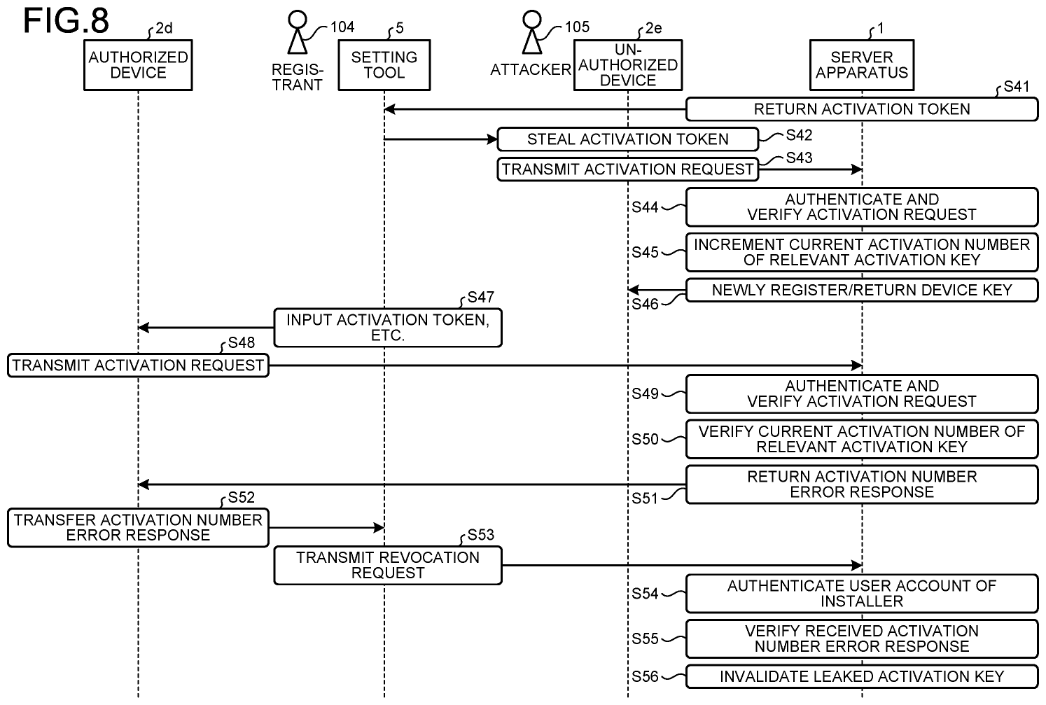

FIG. 8 is a view illustrating an example of a processing sequence of fraud detection of the first embodiment. The example of FIG. 8 illustrates the processing sequence for detecting that an attacker 105 has validated an unauthorized device 2e.

As a premise, it is assumed that the attacker has stolen the activation key pair installed in an authorized device 2d by some method and has installed the activation key pair in the unauthorized device 2e possessed by the attacker. In this state, it is assumed that the setting operation of the authorized device 2d is started and the setting tool 5 has transmitted the activation token issue request.

First, the communication unit 11 of the server apparatus 1 verifies and processes the activation token issue request in the procedure illustrated in FIG. 6, and returns the activation token (step S41) Here, the attacker 105 steals the activation token, received by the setting tool 5 from the server apparatus 1, by some method (step S42). This is realized, for example, by installing spyware in the setting tool 5 in advance. The attacker 105 installs the activation token stolen in step S42 in the unauthorized device 2e.

Next, the unauthorized device 2e creates an activation request using the activation key and the activation token stolen by the attacker 105 and the device key of the unauthorized device 2e, and sends the activation request to the server apparatus 1 (step S43).

Next, the server apparatus 1 authenticates and verifies the activation request in the procedure illustrated in FIG. 6 (step S44). Here, since the unauthorized device 2e steals the activation key and the activation token issued to the authorized device 2d, the server apparatus 1 cannot detect a fraud at this time.

Next, the processing unit 19 of the server apparatus 1 adds 1 to the current activation number of the activation key (step S45). In the present embodiment, at this time point, the maximum activation number of the activation key is 1, and the current activation number is 1.

Next, in step S43, the processing unit 19 registers the entry of the device key (public key), included in the activation request transmitted from the unauthorized device 2e, in the device key storage unit 15 and returns information such as the device key identifier, issued at the time of registration of the entry, to the unauthorized device 2e (step S46).

Thereafter, the setting tool 5 inputs the activation token, wireless LAN authentication information of the installation place 103, and the like to the authorized device 2d in the procedure illustrated in FIG. 6 (step S47).

The authorized device 2d transmits the activation request to the server apparatus 1 in the procedure illustrated in FIG. 6 (step S48).

Next, the authentication unit 12 and the processing unit 19 of the server apparatus 1 authenticate and verify the activation request transmitted in step S48 (step S49). The verification is passed, and the server apparatus 1 continues the processing.

Next, the server apparatus 1 verifies that the current activation number is less than the maximum activation number according to the procedure illustrated in FIG. 6 (step S50). In the case of the example of FIG. 8, since the unauthorized device 2e has already validated its own device key, the current activation number is the same value as the maximum activation number. Thus, this verification will fail.

Next, the processing unit 19 creates an activation number error response and returns the response to the authorized device 2d (step S51). The activation number error response includes the following information.

Activation key identifier in which error occurs

Activation token character string in which error occurs

Expiration of this response (for example, time ahead of current time by 30 minutes)

Electronic signature created with server key (private key) for all the above information

Next, the authorized device 2d transfers the activation number error response, received from the server apparatus 1, to the setting tool 5 (step S52). The transfer method may be, for example, the same as the communication method used when the setting tool 5 inputs the activation token or the like to the authorized device 2d. For example, the transfer method may be a method in which the activation number error response is displayed as a QR code on a display included in the authorized device 2d, and is read by a camera of the setting tool 5. At that time, the authorized device 2d may attract an attention of the installer 104 and prompt reading of the activation number error response. Specifically, the authorized device 2d may attract the attention of the installer 104 by outputting a sound from a speaker, blinking an LED, or the like.

Next, the server communication unit 51 of the setting tool 5 sends a revocation request to the server apparatus 1 (step S53). Assuming that the activation key of the authorized device 2d is stolen by the attacker 105, the revocation request is a request for requesting the server apparatus 1 to invalidate the activation key and all device keys validated by the activation key. The revocation request includes the activation number error response transferred from the authorized device 2d and the authentication information of the installer 104.

Next, when the communication unit 11 of the server apparatus 1 receives the revocation request from the setting tool 5, the authentication unit 12 authenticates that the revocation request is made by the installer 104 (step S54). For this authentication, password authentication using the authentication information (for example, user identifier and password) included in the revocation request and the authentication information (for example, user identifier and password) recorded in the user account storage unit 13 may be used, or authentication using a token acquired in advance by OAuth 2.0 Authorization Code Flow may be used. When the authentication fails, the authentication unit 12 discards the revocation request, and the communication unit 11 returns an error to the setting tool 5.

Next, the processing unit 19 of the server apparatus 1 verifies authenticity of the activation number error response included in the revocation request (step S55). Specifically, the processing unit 19 first verifies that the electronic signature added to the activation number error response is based on the server key of the server apparatus 1. Next, the processing unit 19 verifies that the expiration of the activation number error response is a time later than the current time. When any of these verifications fails, the server apparatus 1 discards the revocation request, and the communication unit 11 returns an error to the setting tool 5.

Next, when the verification in step S55 is successful, the processing unit 19 invalidates the leaked activation key (step S56). Specifically, the processing unit 19 deletes the entry having the activation key identifier included in the activation number error response from the activation key storage unit 14. Furthermore, the processing unit 19 deletes the entry of the device key having the activation key identifier from the device key storage unit 15.

With the above processing sequence, the server apparatus 1 can invalidate the activation key stolen by the attacker 105 and the device key of the unauthorized device 2e validated thereby, so that it is possible to prevent the unauthorized device 2e from receiving the service provision of the server apparatus 1. In authenticating the revocation request, the server apparatus 1 requests user account authentication of the installer 104 and presence of then activation number error response including a signature of the server itself. As a result, the invalidation function of the activation key itself can be prevented from being abused by the attacker.

In the first embodiment, the server key, the activation key, and the device key are all assumed to be asymmetric keys (pair of private key and public key); however, these keys may be symmetric keys (shared keys). However, when the device key is the symmetric key, the key itself is sent from the device 2 to the server apparatus 1 by the activation request, and the risk of leakage of the device key increases. In order to prevent this, instead of sending the device key itself as the activation request in FIG. 6, a Diffie-Hellman key exchange algorithm may be performed between the device 2 and the server apparatus 1, and each of the device 2 and the server apparatus 1 may generate and record a common device key.

As described above, the information processing system 100 of the first embodiment includes the server apparatus 1 and the device 2. In the server apparatus 1, the activation key storage unit 14 (first activation key storage unit) stores the activation key that validates the device key used when the device 2 receives the service of the server apparatus 1, the activation key identifier that identifies the activation key, the maximum activation number indicating the number of device keys that can be validated with the activation key, and the current activation number indicating the current number of device keys validated with the activation key. When the processing unit 19 receives an activation request including a first device key and a first activation key identifier from the device 2, the processing unit 19 stores the first device key in the device key storage unit 15 (first device key storage unit) when a first current activation number of the first activation key identified by the first activation key identifier is less than a first maximum activation number. In the device 2, the device key storage unit 36 (second device key storage unit) stores the device key (first device key) of the device 2. The activation key storage unit 32 (second activation key storage unit) stores the first activation key and the first activation key identifier. The activation request unit 38 transmits the activation request to the server apparatus 1.

As a result, according to the information processing system of the first embodiment, even when the activation key is leaked, it is possible to make it difficult for the attacker to illegally use the leaked activation key (for example, see FIG. 8).

### Second Embodiment

Next, a second embodiment will be described. In the description of the second embodiment, the description similar to that of the first embodiment will be omitted, and portions different from those of the first embodiment will be described. In the first embodiment, in the setting operation, the device 2 bidirectionally communicates with the setting tool 5 to exchange information such as the activation token and the activation number error response. However, for example, there is a case where the device 2 cannot have a bidirectional communication function for reasons such as lowering the cost of the device 2, reducing the size of the device 2, or simplifying the setting operation. In the second embodiment, an embodiment in the case where the device 2 does not have the bidirectional communication function will be described.

Functional Configuration of Server Apparatus

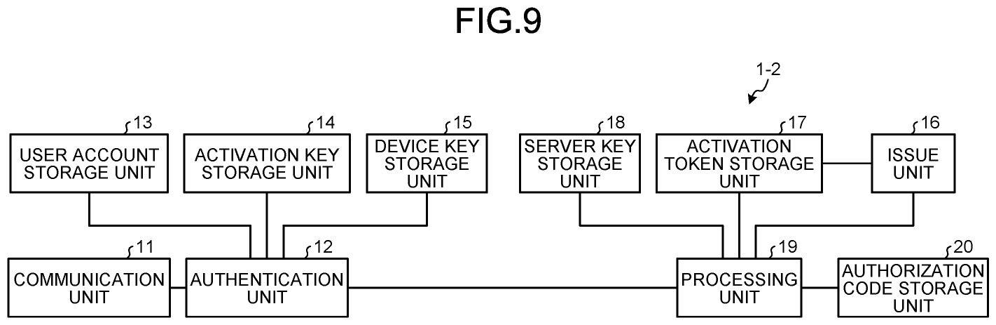

FIG. 9 is a view illustrating an example of a functional configuration of a server apparatus 1-2 of the second embodiment. The server apparatus 1-2 of the second embodiment includes the communication unit 11, the authentication unit 12, the user account storage unit 13, the activation key storage unit 14, the device key storage unit 15, the issue unit 16, the activation token storage unit 17, the server key storage unit 18, the processing unit 19, and an authorization code storage unit 20. A difference from the configuration of the server apparatus 1 of the first embodiment is that the authorization code storage unit 20 is further provided in the present embodiment.

The authorization code storage unit 20 stores an authorization code issued by the server apparatus 1 in accordance with OAuth 2.0 Device Authorization Grant (RFC 8628). The following information is recorded in an entry of the authorization code storage unit 20.

Device code

User code

Expiration

Activation key identifier used for authorization request

Verification completion flag

Functional Configuration of Device

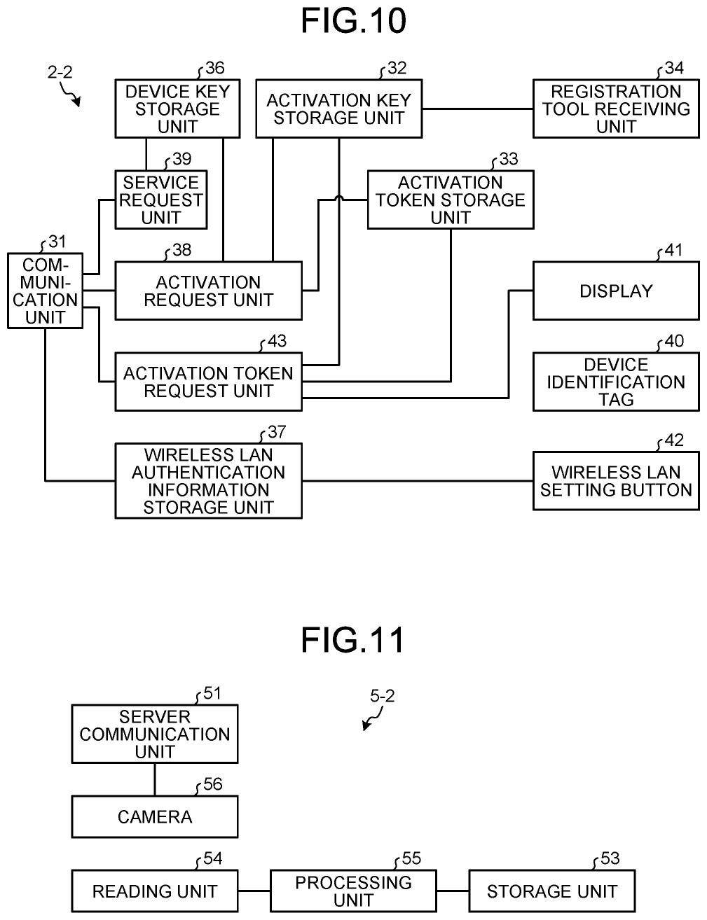

FIG. 10 is a view illustrating an example of a functional configuration of a device 2-2 of the second embodiment. The device 2-2 of the second embodiment includes the communication unit 31, the activation key storage unit 32, the activation token storage unit 33, the registration tool receiving unit 34, the setting tool receiving unit 35, the device key storage unit 36, the wireless LAN authentication information storage unit 37, the activation request unit 38, the service request unit 39, the device identification tag 40, a display 41, a wireless LAN setting button 42, and an activation token request unit 43. A difference from the configuration of the device 2 of the first embodiment is that the present embodiment further includes the display 41, the wireless LAN setting button 42, and the activation token request unit 43 instead of the setting tool receiving unit 35.

In the setting operation, the display 41 displays the user code, the activation number error response, and the like to transmit to the setting tool 5.

The wireless LAN setting button 42 is used to acquire wireless LAN authentication information of an installation place 103 in the setting operation.

The activation token request unit 43 performs request processing for acquiring the activation token from the server apparatus 1.

Functional Configuration of Setting Tool

FIG. 11 is a view illustrating an example of a functional configuration of the setting tool 5-2 of the second embodiment. The setting tool of the second embodiment includes the server communication unit 51, the storage unit 53, the reading unit 54, the processing unit 55, and a camera 56. In the present embodiment, the camera 56 is further provided instead of the device communication unit 52.

In the setting operation, the camera 56 reads information displayed on the display 41 of the device 2. The camera 56 may be the same as the reading unit 54.

The processing sequence of the initial registration operation and the processing sequence of the service provision of the second embodiment are the same as those of the first embodiment. In the processing sequence of the setting operation, the device 2-2 of the present embodiment has a more limited information input function than the device 2 of the first embodiment, and thus a different processing sequence is adopted. Specifically, the device 2-2 acquires the activation token from the server apparatus 1 in accordance with OAuth 2.0 Device Authorization Grant (RFC 8628).

Processing Example of Setting Operation

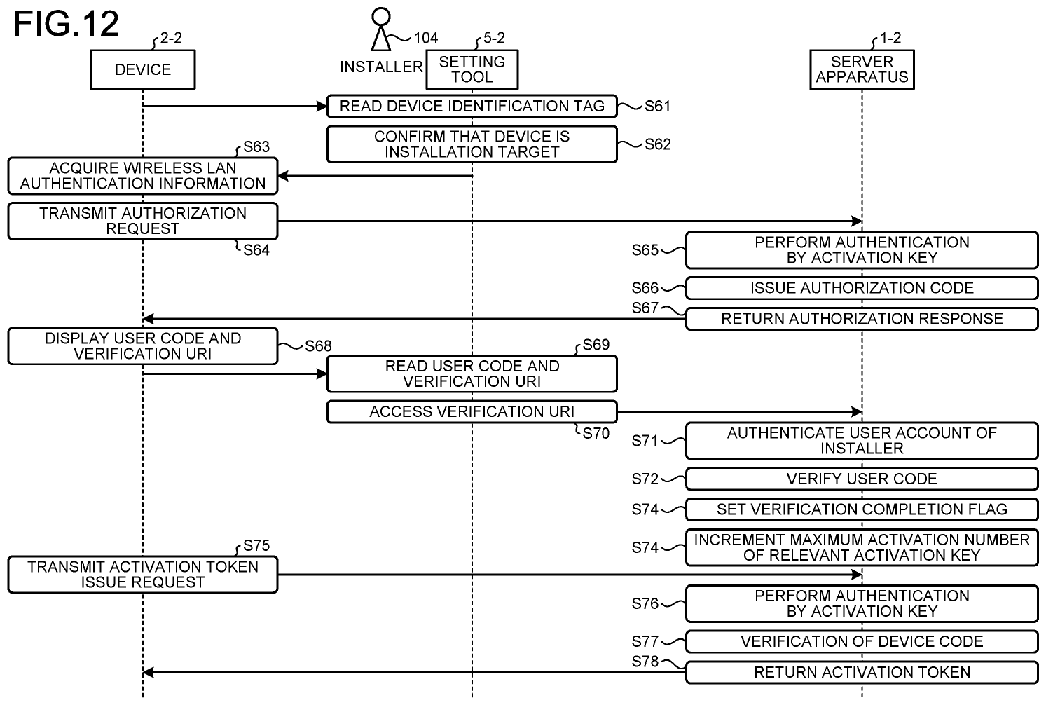

FIG. 12 is a view illustrating an example of the processing sequence of the setting operation of the second embodiment. Since steps S61 and S62 are the same as steps S11 and S12 (see FIG. 6) of the first embodiment, description thereof is omitted.

Next, in response to the operation of the installer 104, the device 2-2 sets the wireless LAN authentication information in the device 2-2 by using WiFi Protected Setup (WPS) (step S63). Specifically, for example, the device 2-2 accepts pressing of the wireless LAN setting button 42 from the installer 104. After the wireless LAN setting button 42 of the device 2-2 is pressed, the wireless LAN access point of the installation place 103 accepts pressing of a WPS button from the installer 104. By an automatic setting function of the WPS, the device 2-2 can acquire the wireless LAN authentication information of the installation place 103 and thus connect to a communication network 3b through a wireless LAN of the installation place 103.

Next, the communication unit 31 of the device 2-2 transmits an authorization request to the server apparatus 1-2 (step S64). The authorization request is a request that the device 2-2 indirectly requests permission for the installer 104 to validate the device key. The authorization request includes the following information.

Activation key identifier of device 2-2

Creation time of authorization request

Request identification character string randomly generated in device 2-2

Electronic signature created with activation key (private key) for all the above information

Next, when the communication unit 11 of the server apparatus 1-2 receives the authorization request from the device 2-2, the authentication unit 12 authenticates authenticity of the authorization request (step S65). Specifically, the authentication unit 12 verifies the electronic signature added to the authorization request with the activation key (public key) identified by the activation key identifier included in the authorization request. The authentication unit 12 may further perform another verification. For example, the authentication unit 12 may further verify that the creation time included in the authorization request is a past time sufficiently close to the current time. Furthermore, for example, the authentication unit 12 may further verify that the request identification character string included in the authorization request is received for the first time within a certain period of time. When the authorization request is determined to be unauthorized as a result of the verification, the authentication unit 12 stops processing the authorization request and returns an error message to the device 2-2.

Next, the processing unit 19 creates a new entry in the authorization code storage unit 20 and issues the authorization code (step S66). At that time, the processing unit 19 generates and sets different random character strings in a device code field and a user code field. In an expiration field, the processing unit 19 sets a value (for example, after 10 minutes) ahead of the current time by a suitable time. The processing unit 19 sets the activation key identifier included in the authorization request in a field of “activation key identifier used for authorization request”. Then, the processing unit 19 sets “not completed” in a verification completion flag field.

Next, the processing unit 19 creates an authorization response, and the communication unit 11 returns the authorization response to the device 2-2. The authorization response includes the following information.

Device code generated in step S66

User code generated in step S66

Expiration set in step S66

Verification URI (uniform resource indicator).

The verification URI is a URI prepared in advance by the server apparatus 1-2. In a later step, a setting tool 5-2 accesses this URI in response to an operation input of the installer 104, and the server apparatus 1-2 responds to the access.

Next, the device 2-2 temporarily records the authorization response received from the server apparatus 1-2, and displays the verification URI and the user code on the display 41 (step S68). For example, the display 41 displays the verification URI as a QR code and displays the user code as a character string. Furthermore, for example, when the server apparatus 1-2 includes the verification URI incorporating the user code in the authorization response, the display 41 may only display the verification URI as the QR code. For example, when the device 2-2 displays these pieces of information on the display 41, the device 2-2 may output a sound or blink an LED to attract the attention of the installer 104.

Next, the camera 56 of the setting tool 5-2 reads the verification URI and the user code displayed on the display 41 of the device 2-2 in response to the operation of the installer 104 (step S69).

Next, the server communication unit 51 accesses the verification URI read in step S69 (step S70). In response to the request sent from the setting tool 5-2 to the verification URI, the server apparatus 1-2 returns a verification web page, requesting the installer 104 for permission for validation of the device key, to the setting tool 5-2.

Next, the authentication unit 12 of the server apparatus 1-2 authenticates that a person accessing the verification web page is the installer 104 (step S71). The authentication in step S71 may be, for example, authentication using a user identifier and a password of the installer 104 stored in the user account storage unit 13, or authentication using a token acquired in advance by OAuth 2.0 Authorization Code Flow.

Next, when the server communication unit 51 of the setting tool 5-2 transmits the user code to the server apparatus 1 via the verification web page, the processing unit 19 of the server apparatus 1 verifies the user code (step S72). Specifically, for example, the installer 104 may read the user code from the display 41 of the device 2-2, and a form of the verification web page may accept an input of the user code from the installer 104. For example, the setting tool 5-2 may read the user code directly from the display 41 of the device 2-2 and transmit the user code to the server apparatus 1-2. When the processing unit 19 receives the user code from the setting tool 5-2, the processing unit 19 reads the entry including the user code from the authorization code storage unit 20. The processing unit 19 verifies that the expiration field of the entry is a time later than the current time and that a verification completion flag is “not completed”. When any of the verifications fails, the processing unit 19 stops the processing and displays the error message on the verification web page.

Next, when the verification in step S72 is passed, the processing unit 19 updates the entry and sets “completed” in the verification completion flag field (step S73).

Next, the processing unit 19 reads the field of “activation key identifier used for authorization request” of the entry updated in step S73, and reads the entry including this activation key identifier from the activation key storage unit 14. The processing unit 19 adds 1 to the maximum activation number of the entry (step S74).

Next, the activation token request unit 43 of the device 2-2 sends an activation token issue request to the server apparatus 1-2 via the communication unit 31 (step S75). This transmission of the activation token issue request is performed asynchronously with an act of the installer 104 after the device 2-2 displays the user code and the verification URI on the display 41. The activation token issue request includes the following information.

Device code received from server apparatus 1-2 in authorization response

Activation key identifier of device 2-2

Time at which activation token issue request has been created

Randomly generated activation token issue request identification character string

Electronic signature created with activation key (private key) for all the above information

Next, when the communication unit 11 of the server apparatus 1-2 receives the activation token issue request from the device 2-2, the processing unit 19 authenticates authenticity of the activation token issue request (step S76). Specifically, the processing unit 19 performs electronic signature verification using the activation key (public key), and the like, similarly to the authentication of the authorization request.

Next, when the verification in step S76 is passed, the issue unit 16 verifies the device code included in the activation token issue request (step S77). Specifically, the issue unit 16 confirms that the user code corresponding to the device code included in the activation token issue request has been received from the setting tool 5-2. Furthermore, the issue unit 16 reads the entry including the received device code from the authorization code storage unit 20. The issue unit 16 verifies that the expiration of the entry is a time later than the current time, that the activation key identifier of the entry is the same as the activation key identifier included in the request, and that the verification completion flag of the entry is “completed”. When any one of the verifications fails, the issue unit 16 stops the processing, and the communication unit 11 returns the error message to the device 2-2.

When the activation token issue request is transmitted by the device 2-2 too earlier than the operation of the installer 104, it is sufficiently possible that the verification completion flag is “not completed” at the time of transmitting the request. When the device 2-2 receives the error message indicating the fact from the server apparatus 1-2, the device 2-2 waits for a suitable time and then transmits the activation token issue request to the server apparatus 1-2 again.

Next, when the verification in step S77 is passed, the issue unit 16 issues an activation token and returns the activation token to the device 2-2 (step S78). The procedure at this time is similar to that of the first embodiment.

According to the above processing sequence, the device 2-2 can acquire the activation token directly from the server apparatus 1-2 without being through the setting tool 5-2. Thereafter, the device 2-2 validates the device key of the device 2-2 using the activation token according to a procedure similar to that of the first embodiment. Similarly to the first embodiment, the activation token issued in the present embodiment cannot be issued unless the installer 104 authenticated by the server apparatus 1-2 clearly gives authorization on the verification web page. As a result, it is possible to prevent unauthorized activation token issue by the attacker 105.

In the above example, the device 2-2 uses the display 41 and the setting tool 5-2 uses the camera 56 to transmit the user code and the verification URI; however, the user code and the verification URI may be transmitted by another method. For example, the user code and the verification URI may be transmitted by a method such as infrared communication, visible light communication, voice communication, or ultrasonic communication.

Although the above processing sequence conforms to an OAuth 2.0 Device Authorization Grant standard, the present embodiment can be implemented without strictly following this standard. For example, in the above processing sequence, the device 2-2 acquires the activation token from the server apparatus 1-2 and then transmits the activation request; however, both may be combined. In this case, the device 2-2 includes the device key (public key) in the activation token issue request of FIG. 12, and the server apparatus 1-2 verifies authenticity of the request with request authentication using the activation key and verification of the device code. When these verifications are passed, the server apparatus 1-2 verifies and adds the number of activations, and registers the device key.

The processing sequence for detecting that the attacker 105 has validated an unauthorized device 2e is similar to the processing sequence of the first embodiment (see FIG. 8) also in the present embodiment. However, when an authorized device 2d transfers an activation number error response to the setting tool 5-2, a communication method similar to that when the user code and the verification URI are displayed in the setting tool 5-2 in FIG. 12 is used.

Finally, an example of a hardware configuration of each of the server apparatuses 1 to 1-2 of the first and second embodiments will be described.

Example of Hardware Configuration

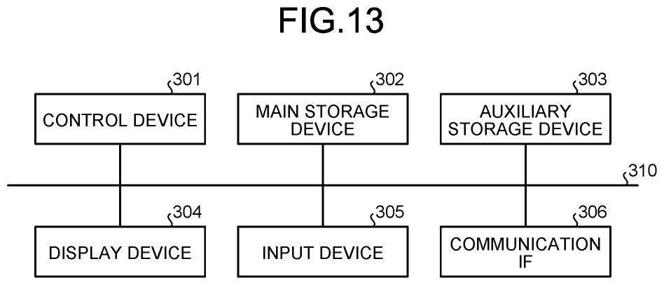

FIG. 13 is a view illustrating the example of the hardware configuration of each of the server apparatuses 1 to 1-2 of the first and second embodiments.

The server apparatuses 1 to 1-2 include a control device 301, a main storage device 302, an auxiliary storage device 303, a display device 304, an input device 305, and a communication IF 306. The control device 301, the main storage device 302, the auxiliary storage device 303, the display device 304, the input device 305, and the communication IF 306 are connected via a bus 310.

The control device 301 executes a program read from the auxiliary storage device 303 to the main storage device 302. The main storage device 302 is a memory such as a ROM (Read Only Memory) and a RAM (Random Access Memory). The auxiliary storage device 303 is an HDD (Hard Disk Drive), an SSD (Solid State Drive), a memory card, or the like.

The display device 304 displays display information. The display device 304 is, for example, a liquid crystal display or the like. The input device 305 is an interface for operating a computer operated as the server apparatuses 1 to 1-2. The input device 305 is, for example, a keyboard, a mouse, or the like. Note that the display device 304 and the input device 305 may use a display function and an input function of an external management terminal or the like that can be connected to the server apparatuses 1 to 1-2.

The communication IF 306 is an interface for communicating with other devices.

The program executed by the computer is recorded in an installable or executable file format on a computer-readable storage medium such as a CD-ROM, a memory card, a CD-R, or a DVD (Digital Versatile Disc), and is provided as a computer program product.

In addition, the program executed by the computer may be stored in a computer connected to a network such as the Internet and provided by being downloaded via the network. The program executed by the computer may be provided via a network such as the Internet without being downloaded.

The program executed by the computer may be incorporated in advance in a ROM or the like and provided.

The program executed by the computer has a module configuration including a functional block that can also be realized by the program among functional configurations (functional blocks) of the server apparatuses 1 to 1-2 described above. As actual hardware, each of the functional blocks is loaded on the main storage device 302 by the control device 301 reading and executing the program from the storage medium. That is, each of the functional blocks is generated on the main storage device 302.

Some or all of the functional blocks described above may not be implemented by software, but may be implemented by hardware such as an IC (Integrated Circuit).

When each function is realized by using a plurality of processors, each processor may realize one of the functions or may realize two or more of the functions.

Operation forms of the server apparatuses 1 to 1-2 of the first and second embodiments may be arbitrary. The server apparatuses 1 to 1-2 of the first and second embodiments may be operated as, for example, a device constituting a cloud system on a network.

The hardware configurations of main parts of the device 2, the registration tool 4, and the setting tools 5 to 5-2 of the first and second embodiments are also similar to the hardware configurations of the server apparatuses 1 to 1-2. Note that, in the device 2, a part of the hardware configuration (for example, display device 304, input device 305, and the like) may be deleted, or a part of the hardware configuration (for example, various sensors, imaging devices, and the like) may be added.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a server apparatus; and
a device, wherein
the server apparatus comprises:
a first activation key storage unit that stores an activation key that validates a device key used when the device receives a service of the server apparatus, an activation key identifier that identifies the activation key, a maximum activation number indicating a number of the device keys that the activation key is capable of validating, and a current activation number indicating a current number of device keys validated with the activation key; and
a processing unit that stores a first device key in a first device key storage unit in a case where a first current activation number of a first activation key identified by a first activation key identifier is less than a first maximum activation number, when the processing unit receives an activation request including the first device key and the first activation key identifier from the device, and
the device comprises:
a second device key storage unit that stores the first device key;
a second activation key storage unit that stores the first activation key and the first activation key identifier; and
an activation request unit that transmits the activation request to the server apparatus.

2. The system according to claim 1, wherein
the activation request unit transmits the activation request further including an authentication code using the first activation key to the server apparatus, and
the server apparatus further comprises an authentication unit that verifies the authentication code by the first activation key identified by the first activation key identifier and discards the activation request when the authentication code is unauthorized.

3. The system according to claim 1, wherein
the device key is a pair of a device public key and a device private key,
the activation request unit transmits the activation request further including a device electronic signature using a device private key of the first device key to the server apparatus, and
the processing unit verifies the device electronic signature by the device public key included in the activation request and discards the activation request when verification is not passed.

4. The system according to claim 2, wherein
the server apparatus further comprises a server key storage unit that stores a server key, and
the processing unit returns an activation number error response including an authentication code using the server key and the first activation key identifier, to the device when the first current activation number is not less than the first maximum activation number.

5. The system according to claim 4, further comprising a setting tool, wherein
when the activation request unit receives the activation number error response from the server apparatus, the activation request unit transfers the activation number error response to the setting tool,
when the setting tool receives the activation number error response from the device, the setting tool transmits a revocation request including the activation number error response to the server apparatus,
when the processing unit receives the revocation request from the setting tool, the processing unit verifies the authentication code included in the activation number error response, with the server key, and when verification is passed, the processing unit invalidates the first activation key identified by the first activation key identifier included in the activation number error response and a device key validated by the first activation key.

6. The system according to claim 5, wherein
the server apparatus further comprises a user account storage unit that stores authentication information of an installer of the device,
the setting tool transmits the revocation request further including the authentication information to the server apparatus,
when the authentication unit receives the revocation request from the setting tool, the authentication unit verifies the authentication information included in the revocation request with reference to the user account storage unit, and when verification is not passed, the authentication unit discards the revocation request.

7. The system according to claim 5, wherein
the server apparatus further comprises:
a user account storage unit that stores authentication information of an installer of the device, and
an issue unit that issues an activation token,
the setting tool transmits an activation token issue request including the authentication information and the first activation key identifier to the server apparatus, and, when the setting tool receives a first activation token corresponding to the first activation key identifier from the server apparatus, the setting tool transmits the first activation token to the device,
when the processing unit receives the activation token issue request from the setting tool, the processing unit verifies the authentication information included in the activation token issue request with reference to the user account storage unit, and, when verification is passed, the processing unit increments the first maximum activation number of the first activation key identified by the first activation key identifier,
the issue unit returns the first activation token corresponding to the first activation key identifier to the setting tool,
the activation request unit transmits the activation request further including the first activation token to the server apparatus, and
when the first activation token is not valid, the processing unit discards the activation request.

8. The system according to claim 7, wherein
the device further comprises an activation token request unit that transmits an authorization request including the first activation key identifier to the server apparatus and then transmits the activation token issue request to the server apparatus,
when the processing unit receives the authorization request from the device, the processing unit stores a device code and a user code corresponding to the first activation key identified by the first activation key identifier in an authorization code storage unit, and returns the device code and the user code to the device,
the setting tool acquires the user code from the device and transmits the user code to the server apparatus,
when the processing unit receives the user code from the setting tool, the processing unit increments the first maximum activation number of the first activation key corresponding to the user code,
the activation token request unit transmits the activation token issue request further including the device code to the server apparatus, and
when the issue unit receives the activation token issue request from the device, the issue unit returns the activation token to the device when confirming that the user code corresponding to the device code included in the activation token issue request has been received from the setting tool.

9. The system according to claim 8, wherein
the device further comprises a display that displays the user code, and
the setting tool comprise a camera that captures an image of the user code displayed on the display.

10. A server apparatus comprising:
an activation key storage unit that stores an activation key that validates a device key used when a device receives a service of the server apparatus, an activation key identifier that identifies the activation key, a maximum activation number indicating a number of the device keys that the activation key is capable of validating, and a current activation number indicating a current number of device keys validated with the activation key, and
a processing unit that stores a first device key in a device key storage unit in a case where a first current activation number of a first activation key identified by a first activation key identifier is less than a first maximum activation number, when the processing unit receives an activation request including the first device key and the first activation key identifier from the device.

11. A computer program product comprising a non-transitory computer-readable medium including programmed instructions, the instructions causing a computer of a server apparatus to function as a processing unit,
the server apparatus comprising an activation key storage unit that stores an activation key that validates a device key used when a device receives a service of the server apparatus, an activation key identifier that identifies the activation key, a maximum activation number indicating a number of the device keys that the activation key is capable of validating, and a current activation number indicating a current number of device keys validated with the activation key,
the processing unit storing a first device key in a device key storage unit in a case where a first current activation number of a first activation key identified by a first activation key identifier is less than a first maximum activation number, when the processing unit receives an activation request including the first device key and the first activation key identifier from the device.
